(19) United States
(12) Patent Application Publication
(10) Pub. No.: US 2014/0154398 A1
(43) Pub. Date: Jun. 5, 2014

(54) AGAVE SWEETENER COMPOSITION AND CRYSTALLIZATION PROCESS

(71) Applicant: Gilbert Bustamante, Beverly Hills, CA (US)

(72) Inventor: Marco Antonio Diaz Medina, Aguascalientes (MX)

(73) Assignee: Gilbert Bustamante, Beverly Hills, CA (US)

(21) Appl. No.: 14/095,722

(22) Filed: Dec. 3, 2013

Related U.S. Application Data
(60) Provisional application No. 61/733,386, filed on Dec. 4, 2012.

(51) Int. Cl. A23L 1/236

(52) U.S. Cl. CPC A23L 1/2363
USPC 426/658

(57) ABSTRACT

A process for producing a crystallized sweetener from agave syrup by mixing agave syrup with a binder, anticaking agent, and flavor enhancer, evaporating and crystallizing the mixture, and then grinding it to produce a crystallized agave sweetener product.

### CROSS-REFERENCE TO RELATED APPLICATIONS

This application claims the benefit of priority under 35 U.S.C. §120 from U.S. Patent Application No. 61/733,386, filed on Dec. 4, 2012 and entitled AGAVE SWEETENER COMPOSITION AND CRYSTALLIZATION PROCESS. The disclosure of this application is incorporated herein by reference in its entirety.

### BACKGROUND

Agave syrup is a sweetener produced from several species of agave, including Agave tequilana and Agave salmiana. Most agave syrup is produced in Mexico.

Agave syrup consists primarily of fructose and glucose. It is sweeter than table sugar, and can be used in place of sugar. Despite this, agave syrup has a much lower glycemic index and glycemic load than table sugar, and its impact on the body is similar to that of fructose.

One impediment to the wider use of agave syrup, however, is its physical form. Liquid sweeteners such as agave syrup are less convenient to dispense in the small quantities that are often needed for sweetening an individual serving of a food or beverage, such as when sweetening a cup of coffee.

### FIGURES

FIG. 1 is a flow chart illustrating the steps of a preferred embodiment of the present process.

FIG. 2 is a diagram of a preferred system for concentrating agave syrup.

### SUMMARY

Prior to the present process, large-scale production of a crystallized sweetener from agave syrup has not been possible due to the difficulty of manufacturing such a composition. Crystal sweeteners made from agave syrup and having a low glycemic index likewise have not been available. The present process for producing a crystalline agave sweetener involves providing agave syrup, a binder, and an anticaking agent and placing these in a mixer, thereby forming an in-process mixture which is heated to a temperature of between 50° C. and 65° C. while stifling this mixture at a constant rate. Preferably, the agave syrup is 75 Brix and the binder is inulin, which is derived from agave. The in-process mixture is also preferably stirred at a rate of between 10 and 15 revolutions per minute for approximately 60 minutes. When a flavor enhancer is added to the in-process mixture, the mixture is preferably stirred at a constant rate of 10 to 15 rpm for approximately 30 minutes at a constant temperature of 60° C. to 70° C.

Following this, a vacuum is applied to the in-process mixture in order to evaporate water from it. The temperature is maintained at between 50° C. and 65° C. until a concentration of approximately 10% moisture is obtained, in order to avoid damaging the product. The vacuum is preferably at a pressure of between 500 mm Hg and 585 mm Hg. This partially evaporated mixture is next transferred to a first evaporator, and a vacuum is applied at a temperature of between 50° C. and 65° C. to evaporate water from the partially evaporated mixture, until an evaporated mixture having a moisture concentration of between 1% and 2% is produced. Preferably, the evaporator is a thin film evaporator, and heat is provided to the evaporator by steam. The vacuum is also preferably at a pressure of between 500 mm Hg and 610 mm Hg. In a preferred embodiment, after being subjected to heat and vacuum in the first evaporator, the partially evaporated mixture is transferred into a second evaporator for an additional treatment with heat and vacuum, preferably at a temperature of between 50° C. and 65° C. and a pressure of between 500 mm Hg and 585 mm Hg.

The evaporated mixture is then transferred to a freezing tunnel in order to lower the temperature of the evaporated mixture, preferably to 5° C., thereby crystallizing uncrystallized components of the mixture. The resulting product is then processed to produce crystals of 2 millimeters or less in diameter, preferably 0.5 millimeters or less. The crystalline composition produced by the foregoing process comprises crystals having a approximately 18%±8% by weight fructooligosaccharide, 60%±10% by weight fructose, 2%±1% by weight sucrose, and 7%±4% by weight glucose. This composition advantageously has a glycemic index of between 33 and 37 and a caloric content of approximately 2.3 kcal/g.

### DESCRIPTION

### Definitions

As used herein, the following terms and variations thereof have the meanings given below, unless a different meaning is clearly intended by the context in which such term is used.

“About” and “approximately” refer to a quantity within 5% of a stated quantity (i.e., ±5% of the stated amount), more preferably within 3%, 2%, or 1%, unless the context indicates otherwise.

“Agave syrup” refers to an aqueous solution derived from the Agave tequiliana or Agave salmiana plants which comprises primarily fructose and glucose.

“Blast freezing” refers to a process in which a cryogenic liquid or cold air is passed over a product such as a food product, preferably at high velocity, in order to freeze the product.

“Brix” refers to the sugar content of an aqueous solution. One degree Brix (1° Brix) is 1 gram of sucrose in 100 grams of solution and represents the strength of the solution as a percentage by weight (% w/w) (i.e., by mass).

“Evaporator” refers to a device used to vaporize a liquid, i.e. turn the liquid into a gas. In the present process the liquid is generally water, and is vaporized in order to remove it from the remainder of the present composition.

“Glycemic index” refers to a measure of how quickly blood sugar levels (i.e., levels of glucose in the blood) rise after eating a particular food composition. It is the incremental area under the two-hour blood glucose response curve (AUC) following a 12-hour fast and ingestion of a food with a certain quantity of available carbohydrate (usually 50 g). The AUC of the test food is divided by the AUC of the standard (glucose) and multiplied by 100. Preferably, an average value is calculated from data collected in 10 human subjects.

“Saccharide” refers to a carbohydrate (a molecule composed of carbon, hydrogen and oxygen) formed from one or more sugar monomers. Most sugar monomers have the chemical formula CₙH₂ₙOₙ (with n being between 3 and 7), such as glucose and fructose. Saccharides can include both monosaccharides (single sugar monomers) and polysaccharides (composed of a plurality of monosaccharide molecules). Polysaccharides include disaccharides such as sucrose, maltose and lactose, oligosaccharides (comprising two to nine monosaccharides), or larger saccharide polymers.

“Thin film evaporator” refers to a device or component for separating one or more substances from a mixture by distributing the mixture as a thin layers on an inners surface of the evaporator and applying heat and/or vacuum to evaporate one or more substances from the mixture. The remaining solid component(s) of the mixture are then removed mechanically, such as with wipers and/or agitation.

“Tunnel freezer” and “freezing tunnel” refer to device or component for blast freezing or cooling a composition in an elongated housing or enclosure through which a conveyor belt passes. The conveyor belt carries the composition through the housing, an injection system to inject cold air or a cryogenic liquid into the housing, and an exhaust system to evacuate excess gases.

The term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

### Materials

The materials used to produce the crystallized agave sweetener of the present invention include agave syrup, a binder, an anticaking agent, and (optionally) a flavor enhancer. Agave syrup is produced from juice extracted from the core of the agave plant, called the “piña”. The juice is filtered and heated to separate polysaccharide components from the sugars, primarily fructose and glucose. The final syrup product will range in color from light to dark amber, depending on the amount of filtration of the syrup, with dark agave syrup being the least filtered (or unfiltered).

The agave syrup used in the present process, which makes up about 95% by weight of the materials used in the process, is preferably derived from Agave tequilana. It is preferably between 73 and 76 degrees Brix, for example about 75 degrees Brix, and typically tastes 1.4 times as sweet as cane sugar. The syrup also preferably has a moisture content of between 35% and 40%, a total solids (dry matter) content of between 60% and 63%, and a pH of between 4.0 and 6.8. The color can range from clear to golden, amber, or dark amber, with the color of the syrup influencing the color of the final product. The syrup preferably has a high fructose concentration, such as a concentration of >90%, with the remainder of the syrup comprising glucose, other saccharides, and trace minerals such as copper, iron, sodium, calcium, potassium, and magnesium.

A binder is generally used in the present process in order to make the final sweetener composition more granular in form. Binders can be added to the agave syrup in amounts of between 2% and 5% by weight of the starting materials of the composition, preferably about 3%, for example. Preferred binders for use in the present process are rice maltodextrin and/or agave fructans (inulin), though binders can be used, typically other polysaccharides such as maltodextrose or tapioca. Inulin derived from agave has ⅓ the calories of a binder such as starch, and results in a final product which is more than 90% derived from agave, and therefore is preferred for use in the present composition and process. Inulin typically has a pH of between 5 and 9, and the polysaccharides are typically more than 90% fructooligosaccharides, the remainder comprising glucose, fructose and sucrose.

An anticaking agent such as amorphous silicon dioxide is also preferably included in the present composition to help prevent the formation of lumps and avoid moisture absorption in the final product. Anti-caking agents can be added to the agave syrup in amounts of between 1% and 2% by weight of the starting materials of the composition, preferably about 1.5%, for example. A variety of commercially available anticaking agents can be used, such as maltodextrin.

Flavor enhancers and/or flavoring agents can also be added to the present composition, typically in an amount of less than 0.5% by weight of the starting materials, preferably about 0.2%. A variety of flavoring agents or enhancers can be added to the present composition. In one embodiment, sweeteners having a greater sweetness than sugar are added to enhance the sweetness of the present product. Preferred sweeteners include sucralose and/or stevia, though other sweeteners such as saccharin, aspartame, and/or sucralose can be used. These are added however only if greater sweetness is desired in the final product.

### Process

a) Agave Syrup Transfer and Homogenization of Ingredients

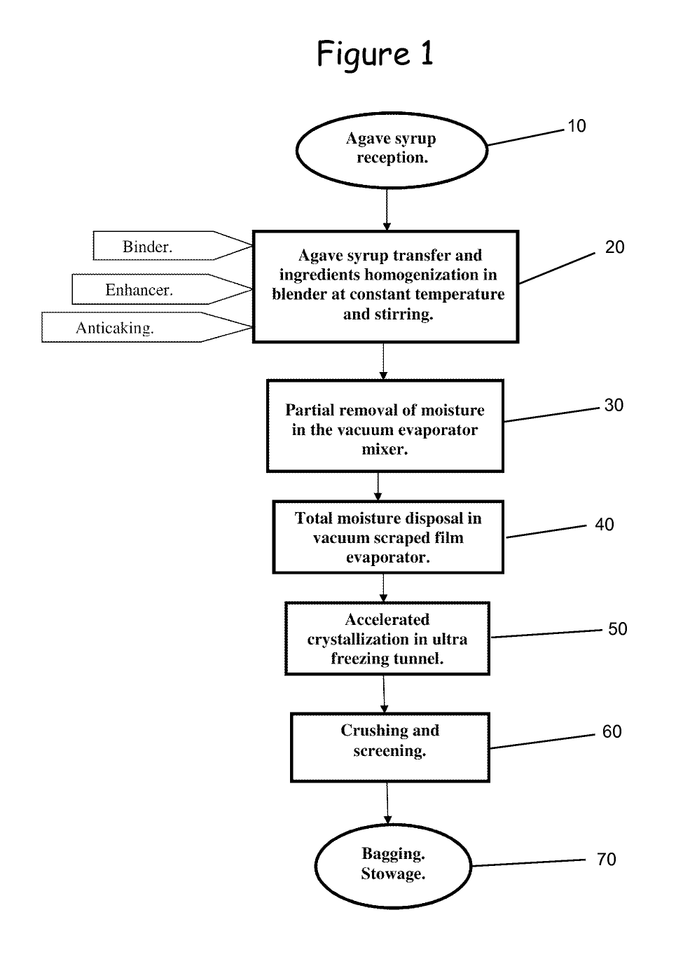

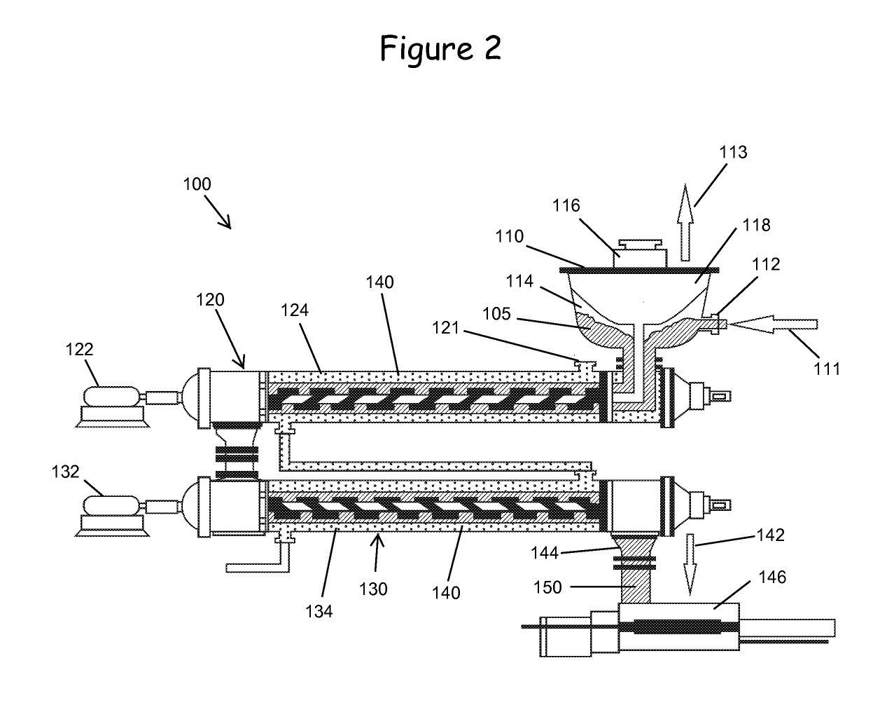

A preferred process and system for producing the crystallized agave sweetener composition of the present invention are illustrated in FIGS. 1 and 2, respectively. As shown in FIG. 1, agave syrup (preferably selected or adjusted to 75 degrees Brix) is first received in step 10, such as in containers, and in step 20 is then transferred into a blender or mixer 110 for mixing of the components of the present composition. The components of the in-process mixture 105 are preferably supplied to the mixer 110 of the present system 100 (FIG. 2) through a port 112 by a positive displacement pump, as illustrated by arrow 111. The syrup in the mixer 110 is stirred with a constant stirring at 10 to 15 revolutions per minute (rpm), preferably with a jacketed scraper. The temperature in the mixer 110 is maintained at between about 50° C. and 65° C., which facilitates the mixture flow.

Using a hopper 116, the binder and the anticaking agent are slowly added to the mixing reactor 114 (step 20) with a constant stifling of 10 to 15 rpm and at a controlled temperature of 50° C. to 65° C. These components are mixed to homogeneity, forming a uniform, clear (generally somewhat yellow) mixture without lumps. This part of the process is very important because if these ingredients are not fully incorporated, the composition will loose consistency in the final crystallization. In this step, the temperature and stifling rate are kept constant for approximately 60 minutes.

If desired, a flavor enhancer can then be combined with a portion of the agave syrup in order to obtain a completely dispersed mixture. Once the flavor enhancer is fully dispersed, this mixture is then added to the mixing reactor with a constant stifling of 10 to 15 rpm for approximately 30 minutes at a constant temperature of 60° C. to 70° C., until the mixture is dispersed and homogenized without any lumps.

b) Partial Elimination of Moisture in Vacuum Evaporator Mixer

Once the mixture 105 is fully homogeneous, the mixer 110 is preferably sealed and vacuum pressure is applied, as indicated by arrow 113 in FIG. 2. A vacuum of preferably between 20 and 24 inches of Hg (about 500 mm Hg to 610 mm Hg, or about 67 kPa to 81 kPa), and more preferably of up to 23 inches of mercury (585 mm Hg or 78 kPa), is applied in order to reduce the pressure within the mixer below atmospheric pressure, in order to evaporate water from the mixture into a steam expansion chamber 118 of the mixer 110 more quickly and at a lower temperature. Evaporation preferably takes place at a temperature of between 50° C. and 65° C. The use of such a constant low temperature helps to prevent the degradation of enzymes and other naturally occurring substituents in the agave syrup.

In this step of the process (step 30, FIG. 1), the in-process mixture is concentrated to between about 87% and 90% solids (up to 95% solids) while leaving the product fully homogeneous. The evaporation rate at this stage is generally 60 to 70 liters per hour, and is maintained until a concentration of about 90% solids (i.e., 10% moisture content) is obtained. Once the mixture is concentrated to 90% solids, it is preferably transferred to a storage tank (such as with a positive displacement pump) at a constant temperature (preferably 65° C.) and slow stirring, e.g. 5 to 10 rpm, in order to keep the mixture homogeneous.

c) Total Elimination of Moisture in Horizontal Film Evaporator

The partially evaporated mixture from step 30 is then transferred (preferably by gravity) in step 40 from the storage tank into an evaporator 120, preferably a horizontal, scraped film evaporator (also referred to as a wiped film or thin film evaporator), in order to remove the remaining water in the mixture. The flow of the partially evaporated mixture is preferably about 8 kg/min and is controlled by a valve on the storage tank. The mixture is preferably evaporated at a rate of 90 to 120 liters of water per hour at a vacuum pressure of 20 to 24 inches of Hg (about 500 mm Hg to 610 mm Hg, or about 67 kPa to 81 kPa) at about 65° C. In a preferred evaporator, the mixture is spread as a thin film on a cylindrical surface in chambers inside the evaporators 120, 130. Heat is then provided in the evaporators in order to speed evaporation, preferably using steam (140 in FIG. 2). In the illustrated embodiment, steam 140 is provided to heat exchange tubes 124 in the first evaporator 120 through steam inflow port 121, and is circulated to heat exchange tubes 134 in the second evaporator.

Flow of the mixture within the evaporators is preferably provided using gear motors with variable speed drives (122, 132), with agitation being provided by scrapers or paddles. The evaporation of water in the mixture occurs when a thin film of the mixture moves through the length of the evaporator (e.g., in the form of a cylinder), releasing water as steam in the center of the reactor following suction flow, due to the fact that the mixture is being heated under vacuum pressure, with the temperature being maintained through the use of a jacket through which a thermal fluid passes (e.g., steam 140). In this process, the pressure within the evaporator's internal chamber is lowered below standard atmospheric pressure, causing the water in the mixture to evaporate faster at a low temperature and eliminating moisture until the product reaches a moisture content of between 1% and 2%. The use of vacuum evaporation is advantageous because there is no degradation of the constituents of the final product.

In the preferred embodiment illustrated in FIG. 2, this process involves passage of the partially evaporated mixture through a series of two evaporators, 120 and 130. When the mixture reaches the end of the second evaporator 130, it exits the evaporation system 100 through an exit conduit 144 as an evaporated mixture 150 having a moisture content of between 1% and 2%. This mixture 150 is then transferred in step 50 though a pump 146 for crystallization.

d) Accelerated Crystallization in Freezing Tunnel

Once the evaporated mixture 150 exits the evaporator 130 with a moisture content of between 1% and 2%, it is preferably transferred using a positive displacement pump having screws (also referred to as a screw pump or worm pump) to an extruder in order to reduce the evaporated mixture 150 to pieces of about 4 mm to 8 mm in diameter. The pieces are then transferred to a blast freezer, such as a tunnel freezer, for rapid cooling. Preferably, the product at this point is placed onto a conveyor belt which carries the pieces to a dry ultra freezing tunnel, preferably at rate of 8 kg/min to 9 kg/min. The freezing tunnel preferably operates at a temperature of between about −20° C. and −35° C., which is preferably achieved using cryogenic liquids, and the temperature of the evaporated mixture 150 is lowered from 65° C. to 5° C. This operation is done to speed cooling in order to avoid having the dried mixture regain moisture by hygroscopicity, which causes loss of anticaking properties and shortens the shelf-life of the product. It also further crystallizes the present composition.

e) Crushing, Screening and Bagging

As the crystallized composition exits the freezing tunnel, it is further processed in step 60 in order to produce crystals of the appropriate size, for example crystals of 2 millimeters or less. Preferably, the composition is transferred to a claws mill that reduces the particle size of the composition. The mill preferably also comprises screens or sieves to sort particles by size and allow the separation and selection of particles of a desired size.

Once milled and sorted, the final product is transferred in step 70 to containers for shipment and/or sale. The crystals are preferably moved by vibration into a hopper bagger, which places a predetermined amount of the product into an appropriate container, according to desired needs and requirements. The product is then preferably stored for distribution.

### Product

The crystals resulting from the foregoing process can be processed into very fine crystal particles of a size similar to powdered sugar (about 0.01 millimeters in diameter) or into larger granules such as table sugar (0.5-2 millimeters or larger). When dark amber agave syrup is used, the crystals have a bright golden color. The product can be used in the same manner as table sugar or other crystalline sugar products.

The present agave crystal product comprises carbohydrates, amino acids, fiber, vitamins and minerals and fructans. The saccharide constituents of the product typically consist of approximately 18%±8% fructooligosaccharide, 60%±10% fructose, 2%±1% sucrose, and 7%+4% glucose (measured as a percent by weight of the composition as a whole). This compares with sugar from sugar cane crystals, which consist of 100% sucrose (a disaccharide of glucose and fructose). The present agave crystals have a caloric content of approximately 2.3 kcal/g and have a glycemic index of about 35 (i.e., between 33 and 37, preferably between 34 and 36, and most preferably 35), as compared to sugar cane which has a caloric content of 4 kcal/g and a glycemic index of 77 (more than double that of the present composition).

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure.

Recitation of value ranges herein is merely intended to serve as a shorthand method for referring individually to each separate value falling within the range. Unless otherwise indicated herein, each individual value is incorporated into the specification as if it were individually recited herein. All references cited herein are incorporated by reference in their entirety.

What is claimed is:

1. A process for producing a crystalline agave sweetener, comprising the steps of:
(a) providing agave syrup, a binder, and an anticaking agent to a mixer to form an in-process mixture;
(b) heating the in-process mixture to a temperature of between 50° C. and 65° C. while stifling the in-process mixture at a constant rate;
(c) applying a vacuum at a temperature of between 50° C. and 65° C. to evaporate water from the in-process mixture until a concentration of approximately 10% moisture is obtained in the in-process mixture, thereby producing a partially evaporated mixture;
(d) transferring the partially evaporated mixture to a first evaporator and applying a vacuum at a temperature of between 50° C. and 65° C. to evaporate water from the partially evaporated mixture and produce an evaporated mixture having a moisture concentration of between 1% and 2%;
(e) transferring the evaporated mixture to a tunnel freezer in order to lower the temperature of the evaporated mixture; and then
(f) processing the evaporated mixture to produce crystals of 2 millimeters or less in diameter.

2. The process of claim 1, wherein the agave syrup is 75 Brix.

3. The process of claim 1, wherein the binder is inulin.

4. The process of claim 1, wherein the in-process mixture is stirred at a rate of between 10 and 15 revolutions per minute.

5. The process of claim 1, wherein the in-process mixture is heated and stirred in step (b) for approximately 60 minutes.

6. The process of claim 1, further comprising the step of adding a flavor enhancer to the in-process mixture, thereby forming a flavored in-process mixture.

7. The process of claim 1, wherein the flavored in-process mixture is stirred at a constant rate of 10 to 15 rpm for approximately 30 minutes at a constant temperature of 60° C. to 70° C.

8. The process of claim 1, wherein the vacuum in step (c) is at a pressure of between 500 mm Hg and 585 mm Hg.

9. The process of claim 1, wherein the vacuum in step (d) is at a pressure of between 500 mm Hg and 610 mm Hg.

10. The process of claim 1, wherein the evaporator is a thin film evaporator.

11. The process of claim 1, wherein the evaporator is heated with steam supplied to the evaporator.

12. The process of claim 1, wherein following step (d) the partially evaporated mixture is transferred to a second evaporator in order to produce an evaporated mixture having a moisture concentration of between 1% and 2%.

13. The process of claim 1, wherein the freezing tunnel lowers the temperature of the evaporated mixture to 5° C.

14. A crystalline composition derived from agave syrup comprising crystals having a particle size of 2 millimeters or less, wherein the composition comprises approximately 18%±8% fructooligosaccharide, 60%±10% fructose, 2%±1% sucrose, and 7%±4% glucose by weight, and wherein the composition has a glycemic index of between 33 and 37.

15. The composition of claim 14, wherein the composition has a caloric content of 2.3 kcal/g.

16. The composition of claim 14, wherein the crystals of the composition have a particle size of 0.5 millimeters or less.
